(19) United States
(12) Patent Application Publication
(10) Pub. No.: US 2007/0294226 A1
(43) Pub. Date: Dec. 20, 2007

(54) Wireless network that provides location information when queried by a client device

(75) Inventors: Gurinderjit Chahal, Fremont, CA (US); Amalavoyal Chari, Sunnyvale, CA (US)

Correspondence Address: Tropos Networks Patent Dept., PO Box 641867, San Jose, CA, 95164-1867, US

(73) Assignee: Tropos Networks, Inc.

(21) Appl. No.: 11/452,832

(22) Filed: Jun. 14, 2006

(51) Int. Cl. G06F 17/30

(52) U.S. Cl. 707/3

(57) ABSTRACT

An apparatus and method of providing location information to a client device connected to a wireless access network are disclosed. The wireless access network includes a plurality of access nodes, and each access node has location information. A plurality of the access nodes receive a query from the client device, the query being directed to a common IP address, wherein the common IP address is shared amongst the plurality of access nodes. One of the access nodes responds to the query, by providing the location information to the client device.

### FIELD OF THE INVENTION

The invention relates generally to wireless communications. More particularly, the invention relates to a method and apparatus of a wireless network that provides location information when queried by a client device.

### BACKGROUND OF THE INVENTION

Packet networking is a form of data communication in which data packets are routed from a source device to a destination device. Packets can be networked directly between a source node and a destination node, or the packets can be relayed through a number of intermediate nodes.

A wireless network can include a wireless device being connected to a network through a base station that is wired to the network. The wireless device can transmit data packets that are received by the base station and then routed through the network. The wireless network can include many base stations that are each wired to the network. Other wireless networks include wireless mesh networks.

Internet advertising is continually growing at a rapid pace. One goal of internet advertising is to specifically target the advertising to particular clients. The client's location is an ideal piece of information that can be used for targeted advertising. Knowing the client's location allows for advertising of goods and services that are located physically close to the client, and therefore, more likely to be purchased by the client. Additionally, location based advertising is convenient to the client.

GPS (global positioning systems) which can provide client locations are presently being deployed in cell phones. However, laptops and personal computers are not presently utilizing GPS technology.

It is desirable to have a wireless mesh network that provides client location information to network servers or, upon request, to client devices.

### SUMMARY OF THE INVENTION

One example of an embodiment of the invention includes a method of providing location information to a client device connected to a wireless access network that includes access nodes. The method includes each access node having location information. A plurality of the access nodes receive a query from the client device, the query being directed to a common IP address, wherein the common IP address is shared amongst the plurality of access nodes. One of the access nodes responds to the query, by providing the location information to the client device.

Another embodiment of the invention also includes a wireless network. The wireless network includes a plurality of wireless access nodes. Each access node includes a common IP address, a unique IP address and location information. A plurality of the access nodes receive a query directed to the common IP address from a client device. One of the access nodes responds to the query by providing the location information to the client device.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows a wireless network that includes access nodes that provide client device location information.

FIG. 2 is a flow chart showing steps of a method in which an access node provides client location information.

FIG. 3 shows wireless mesh network that includes access nodes that provide client device location information.

### DETAILED DESCRIPTION

As shown in the drawings for purposes of illustration, the invention is embodied in an apparatus and method for a wireless network that provides location information. The location information can be used by web-based servers to target advertising to clients devices connected to the mesh network. A client device connected to the network can obtain location information by querying multiple access nodes with a single (common) IP address, and one of the access nodes responds to the query with location information.

Wireless mesh network can be used to provide access to wireless or wired client devices. Mesh networks have several advantages over other wireless access networks including resilience to failures, fewer backhaul requirements, ease of deployment, ability to self-configure and self-heal, etc. Wireless mesh networks are deployed in indoor LAN environments as well as in outdoor metro-area deployments covering many tens or hundreds of square miles.

It is often desirable to a network operator or to an application provider to have information related to the location of client devices within the network. The operator or application provider can use the client device location information to deliver more targeted content to the client device or to provide more accurate (location-specific) search results to the client device. For example, major search engines such as Google and Yahoo are able to offer search results to web-browser-based clients based on location, allowing the user to search for products or services around a specific location.

One way to obtain the client device location information is through user input. For example, in a Google search, the user can input his zip code or street address in addition to the search terms, thereby allowing the search engine to determine and deliver local search results. A drawback of this approach is that it requires the user to manually input his location and is therefore inconvenient. In some cases, the precise location may not be known to the end-user on the client device. In some cases, the end-user's location may be changing because the user is mobile. In some cases, there may not be an end-user on the client device as is the case with automated meter reading devices, for example. In some cases, there may not be data entry capability on the mobile device, as might be the case on some phone handsets, for example. In the case of some applications such as localized content delivery, there may not be an input form to allow the end-user to input location information. For these reasons, it is advantageous to be able to infer the location of the end-user without requiring the intervention of the end-user.

GPS (Global Positioning System) is an established technology that can be used to accurately obtain location information through receiving and triangulating signals from GPS satellites. One drawback of this approach is that it requires a GPS receiver to be embedded in the client device. This requirement imposes additional cost on the client device. Furthermore, since many devices are not so-equipped today, GPS cannot be used to locate these devices. For these reasons, it is advantageous to have a method to locate an end-user or device without requiring the presence of GPS or other location capability on the end-user device.

Other technologies for determining the location of client devices include network-based location systems employing TDOA (Time Difference Of Arrival), etc. as well as network-assisted or network-based location systems. The embodiments described relate to means of conveying location information to client devices, no matter how the location information is generated or determined.

Wireless mesh networks are deployed in several cities and counties in the US and abroad. Many of these wireless mesh networks are deployed using unlicensed spectrum in the 2.4 GHz and 5 GHz bands. In these unlicensed frequency bands, with FCC regulations on maximum transmit power, the cell-sizes are small—from hundreds to a few thousand feet. In such deployments, anywhere from 10 to 30 wireless mesh access nodes are deployed per square mile to achieve the desired coverage footprint. At such node densities, the average distance between mesh access nodes is between 0.25 and 0.5 miles. Because of the small cell sizes in these networks, the location of the access node is a good approximation to the location of a client device accessing the network through that access node. That is, the access devices are “in the neighborhood” of the client devices.

For emergency services (such as 911), it is necessary to have very precise location information, down to a few tens of feet. For many applications of location-based services, however, it suffices to be able to narrow down the location of the client device to a general neighborhood which may be as much as a quarter to half a mile. For these applications, the location of the access node to which the client device is attached (which is typically within a few hundred to a few thousand feet of the location of the client device) is a good proxy for the location of the client device.

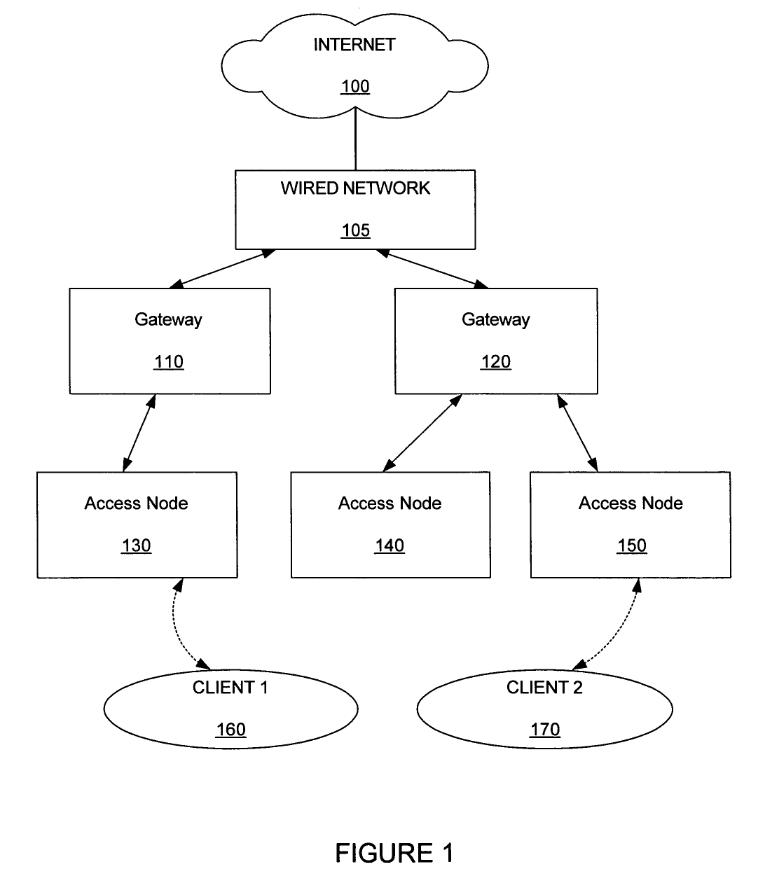

FIG. 1 shows a wireless network that includes access nodes that provide client device location information. The network includes access nodes 130, 140, 150 that client device 160, 170 can use to obtain access to a wired network, such as wired network 105 that is connected to the internet 100. Here, all of the access nodes 130, 140, 150 are wire connected to gateways 110, 120. Knowledge of the locations of the access nodes 130, 140, 150 can be used to obtain an approximate location of the client devices 160, 170 when the client devices 160, 170 are connected to one of the access nodes 130, 140, 150. The access nodes communicate with the client device, for example, according to an IEEE 802.11 protocol.

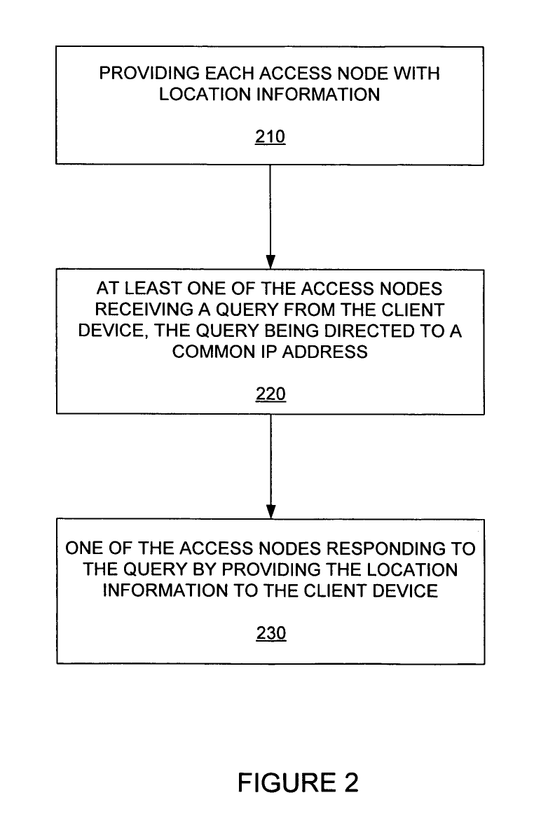

FIG. 2 is a flow chart showing steps of a method of providing location information to a client device connected to a wireless access network. The wireless mesh network includes access nodes that provide network connectivity to a client device. A first step 210 includes providing each access node with location information. Alternatively, each access node can have access to the location information. A second step 220 includes a plurality of the access nodes receiving a query from the client device, the query being directed to a common IP address, wherein the common IP address is shared amongst the plurality of access nodes. A third step 230 includes one of the access nodes responding to the query by providing the location information to the client device.

If a client device desires knowledge of its location, the client device uni-casts a query for location information. The query from the client device is a request for location information in a format specified by the query. The query is directed at a common destination IP address and a multiple number of the access nodes are capable of responding to the query from a client device. One embodiment includes the access node the client device is associated with being the one of the plurality of access nodes that responds to the query.

It is desirable to have a single (common) IP address that the client can query for its location regardless of its point of attachment (access node the client is associated with). Clients can be mobile and move about within the wireless coverage area. Clients can move within the same city or even across cities or networks. The IP address to be queried needs to be reachable from any location and from any of the available networks.

It is possible to achieve this by setting up a server to provide location information to the client and setting up the server with a public IP address that is routable over the Internet. However this approach has several drawbacks. Client location information is typically known locally (i.e., at the access node that the client is associated to) and may not be exportable to a central server on the Internet. It is also desirable to have the information be accessible directly from the access node directly to minimize communication latency.

Each access node has a unique IP address and it may not be possible for the client device to know the IP address of the access node to which it is associated, especially since the client may be mobile and frequently changing its point of association. Therefore it is desirable for each access node to be capable of receiving and responding to location information requests directed at a common IP address. Each access node can be configured with this specific IP address in addition to one or more unique IP addresses. As an example, access node A may be configured with a common IP address, say 192.168.2.3, and a unique IP address, say 10.0.0.1. Access node B may be configured with the same common IP address 192.168.2.3 and a different unique IP address, say 10.0.0.2. In this scenario, either of access node A or B is capable of responding to location requests directed at 192.168.2.3.

For one embodiment, the query from the client device is a request for location information in a format specified by the request.

Access Node Location Information

In wireless mesh networks deployed today, the mesh access nodes are typically mounted on streetlights, traffic lights, utility poles and the like. The location of each access node is recorded when the node is attached to the mounting asset and the network operator typically maintains a database of the node locations in an asset management database. In addition, the access nodes can be configured to have their location information (latitude, longitude, street address, zip code, etc.)—this can be helpful in troubleshooting customer connectivity issues and in providing customer support. Since the access nodes are stationary (mounted to streetlights), their location does not change over time and the configuration settings for node locations are fixed.

There may also be mobile mesh access nodes that are mounted inside vehicles such as police squad cars. Such mobile mesh access nodes may have integrated GPS receivers to dynamically obtain location information as the vehicle moves around. Clearly, GPS receivers can be located in fixed access nodes as well.

In one embodiment, the client device is located in a neighborhood of the access node. The neighborhood can be defined in different ways. One example of a neighborhood includes the neighborhood being defined as being within RF communication range of the access node. The location information can additionally or alternatively include the latitude, longitude, a street address, street intersection identifier, the zip code or the city in which the access node is located.

One embodiment includes the access nodes determining the client device location by characterizing signals received from the client device. For example, the access node the client device is associated with can force dis-association of the client device to the wireless network. The client device then transmits probe requests. A plurality of access nodes of the wireless network receive one or more probe requests from the client after forced dis-association. Each of the plurality of access nodes that receives the probe requests, measures the signal strength of the probe requests. The location of the client device can be estimated based on the received signal strengths (using signal strength to approximate relative distances) at each of the receiving access nodes. The location can be calculated at one or more of the access nodes, but the access nodes need to share the received signal strength information with each other.

For one embodiment, the location information includes a description of a geographical area. For example, the description can include a listing of restaurants in the neighborhood. Other similar descriptions can be used as well.

Data Packets

Several protocols exist for transferring data in packet form from a source to a destination across a network. HTTP (Hyper Text Transfer Protocol) is one common protocol for data transfer. FTP (File Transfer Protocol) is another. Other examples of protocols for data transfer will be obvious to those skilled in the art.

In the HTTP protocol, a client application (such as a web browser on a client device) is used to generate an HTTP Request for a URL (Uniform Resource Locator). The URL identifies the specific resource on an HTTP server that the client application is trying to access. An example URL is http://www.tropos.com/whitepapers/metromesh.pdf. Uniform Resource Identifiers (URIs, also known as URLs) are short strings that identify resources in the web: documents, images, downloadable files, services, electronic mailboxes, and other resources. They make resources available under a variety of naming schemes and access methods such as HTTP, FTP, and Internet mail addressable in the same simple way. The HTTP protocol commonly operates over a transport layer protocol such as TCP (Transmission Control Protocol).

For one embodiment, the query from the client device uses HTTP as a communication protocol. This allows a web browser to send the query (request) in the form of a Java script embedded in the web browser. The response from the access node can use HTTP as a communication protocol, and can include an HTML or an XML file.

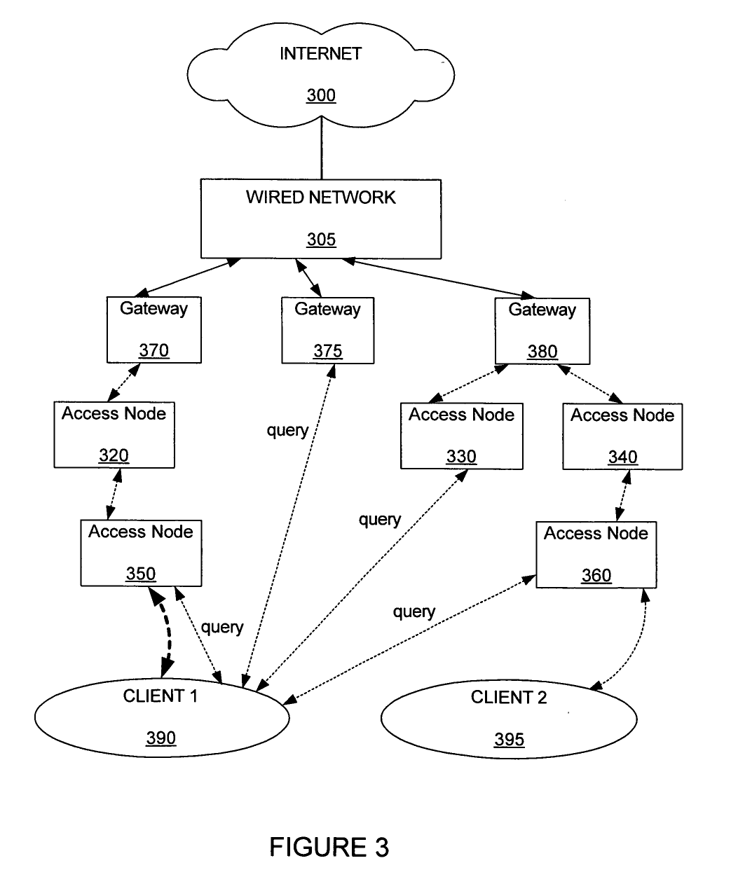

FIG. 3 shows wireless mesh network that includes access nodes 320, 330, 340, 350, 360 that provide client device location information. This network varies from the network of FIG. 1 in that this network is a wireless mesh network. That is, the network of FIG. 3 includes wireless access nodes 320, 330, 340, 350, 360. The access nodes of this mesh network 320, 330, 340, 350, 360 are wirelessly connected to gateways 370, 375, 380. Other configurations can include both wired and wireless access nodes. The mesh network include first order access nodes 320, 330, 340 which are one wireless hop away from a gateway 370, 380, and second order access nodes 350, 360 which are two wireless hops away from a gateway 370, 380. The mesh network can include access nodes having any number of hops away from a gateway. The gateway 375 can be directly connected to a client device 390, requiring the gateway 375 to provide location information to the client device 390 as well. As previously described, all of the wireless links can comply with the IEEE 802.11, or other standard protocol.

An embodiment of the mesh network includes decentralized intelligence in which the access nodes select routing paths from gateways. The routing selections are made by the access nodes themselves, and the mesh network does not need a centralized point intelligence.

The gateways 370, 375, 380 can be wired or wirelessly connected to a wired network 305, which can be connected to the internet 300. The connection of the gateways 370, 375, 380 to the upstream wired networks is typically a very broadband connection, and is commonly referred to as the backhaul. As just mentioned, the backhaul can be a wired or wireless connection. Examples of backhaul connections include Ethernet, fiber, coaxial cable, and wireless point-to-point or point-to-multipoint connections such as those using WiMax. Also, as mentioned, the access nodes can be any number of wireless hops away from a gateway.

In one embodiment, each access node 320, 330, 340, 350, 360, includes a common IP address, a unique IP address, and means for obtaining location information. At least one of the access nodes receives a query from the client device (such as, client device 390), in which the query is directed to the common IP address. One of the access nodes responds to the query by providing the location information to the client device 390. As shown, the gateway 375 can also receive a client device location query. Therefore, the gateway 375 can also include the common IP address. A second client device 395 can also query the access nodes for its location. From the perspective of the client devices 390, 395, it makes no difference whether the responding access node is an access node that is one or more wireless hops away from a gateway, or is a gateway directly connected to a wired network.

As shown, the access node 350 is the access node the client device is associated with, and one embodiment includes this being the one of the plurality of access nodes that receives the query, that responds to the query. Other embodiments include another access node or gateway responding to the query.

An access node may have a web server that is capable of receiving HTTP Requests and responding to them. In one embodiment, HTTP is the protocol used by the client to request location information from the node and the protocol used by the access node to communicate location information to the client. Other protocols such as SOAP may also be used for the client device to request location information and for the access node to respond by communicating location information to the client device, as would be apparent to one skilled in the art.

A client device with software logic on it capable of generating such requests and receiving the responses is able to have access to its approximate location information, even if the client device does not have GPS or other location technology embedded within it. This is advantageous to the client device and enables location-aware applications and programs running on the client device without requiring the client device to have any location technology embedded within it. In addition, the client having access to the location information is capable of embedding the location information directly in the search request, thereby making it unnecessary for an access node to function as an interception proxy and embed location tags in HTTP Requests.

In one exemplary embodiment, the location tag is encrypted using public key cryptography. In this embodiment, the location tag is encrypted using the public key of the search, application or content provider. Only the authorized recipient of this location information (the search, application or content provider, in this example) has the corresponding private key required to decrypt the location tag and extract the location information. This preserves confidentiality of location information and ensures that passive eavesdroppers on the wireless or wired networks are not able to extract sensitive location information by overhearing transmissions.

Although specific embodiments of the invention have been described and illustrated, the invention is not to be limited to the specific forms or arrangements of parts so described and illustrated. The invention is limited only by the appended claims.

What is claimed:

1. A method of providing location information to a client device connected to a wireless access network, the wireless access network comprising access nodes, each access node having access to location information, the method comprising:
a plurality of the access nodes receiving a query from the client device, the query being directed to a common IP address, wherein the common IP address is share amongst the plurality of access nodes; and
one of the access nodes responding to the query by providing the location information to the client device.

2. The method of claim 1, wherein a plurality of the access nodes are within a wireless mesh network, and located at least one wireless hop away from a wireless mesh network gateway.

3. The method of claim 1, wherein the access nodes communicate with the client device according to an IEEE 802.11 protocol.

4. The method of claim 1, wherein the query from the client device is a request for location information in a format specified by the request.

5. The method of claim 1, wherein a plurality of the access nodes are capable of responding to the query from a client device, wherein the query is directed at a common destination IP address.

6. The method of claim 1, wherein any one of the plurality of access nodes that receive the query from the client device directed at the common IP address can respond to the query by providing location information.

7. The method of claim 6, wherein the access node the client device is associated with is the one of the plurality of access nodes that responds to the query.

8. The method of claim 6, further comprising:
providing each access node with the common IP address and a unique IP address.

9. The method of claim 1, wherein the query from the client device uses HTTP as a communication protocol.

10. The method of claim 1, wherein the response from the access node uses HTTP as a communication protocol.

11. The method of claim 1, wherein the response from the access node comprises at least one of an HTML and an XML file.

12. The method of claim 1, wherein the location information is encrypted.

13. The method of claim 1, wherein the client device is located in a neighborhood of the access node.

14. The method of claim 13, wherein the neighborhood is defined as being within RF communication range of the access node.

15. The method of claim 1, wherein location information comprises at least one of the latitude, longitude, a street address, street intersection identifier, the zip code and the city in which the access node is located.

16. The method of claim 1, wherein location information comprises a description of a geographical area.

17. The method of claim 1, wherein access nodes are configured with their location information.

18. The method of claim 1, wherein access nodes obtain their location information through the use of geo-positioning technology.

19. The method of claim 1, wherein the location information is determined by triangulating signals transmitted between the client and multiple access nodes of a mesh network.

20. A wireless network comprising:
a plurality of access nodes, each access node comprising;
a common IP address and a unique IP address;
means for obtaining location information;
a plurality of the access nodes receiving a query from a client device, the query being directed to the common IP address; and
one of the access nodes responding to the query by providing the location information to the client device.
